(19) United States
(12) Patent Application Publication
(10) Pub. No.: US 2022/0159716 A1
(43) Pub. Date: May 19, 2022

(54) METHOD FOR COOPERATIVE RANDOM ACCESS AND ELECTRONIC DEVICE THEREFOR

(71) Applicant: SAMSUNG ELECTRONICS CO., LTD., Suwon-si, Gyeonggi-do (KR)

(72) Inventors: Junsu CHOI, Suwon-si, Gyeonggi-do (KR); Hyunkee MIN, Suwon-si, Gyeonggi-do (KR); Sunkey LEE, Suwon-si, Gyeonggi-do (KR)

(21) Appl. No.: 17/430,095

(22) PCT Filed: Dec. 12, 2019
(86) PCT No.: PCT/KR2019/017568

§ 371 Date: Aug. 11, 2021

(30) Foreign Application Priority Data
Feb. 11, 2019 (KR) 10-2019-0015475

(51) Int. Cl. H04W 74/08; H04W 74/00

(52) U.S. Cl. CPC H04W 74/085; H04W 74/008; H04W 74/006

(57) ABSTRACT

Disclosed is an electronic device including: a communication circuit, a processor operatively connected to the communication circuit, and a memory operatively connected to the processor. The memory may store one or more instructions that, when executed, cause the processor to control the electronic device to: receive a signal including resource information for random access from an external electronic device using the communication circuit, determine random access corresponding to the received signal based on a value of a specified counter, identify a group to which the electronic device belongs based on an address of the electronic device and a number of groups of electronic devices for random access, and transmit a signal for random access to the external electronic device using a resource unit corresponding to a group of the electronic device among a plurality of resource units indicated by the resource information for random access, based on a random access determination.

### CROSS-REFERENCE TO RELATED APPLICATIONS

This application is a national stage of International Application No. PCT/KR2019/017568 designating the United States, filed on Dec. 12, 2019, in the Korean Intellectual Property Receiving Office and claiming priority to Korean Patent Application No. 10-2019-0015475, filed on Feb. 11, 2019, in the Korean Intellectual Property Office, the disclosures of which are incorporated by reference herein in their entireties.

### BACKGROUND

### Field

The disclosure relates to a method of cooperative random access and an electronic device therefor.

### Description of Related Art

With regard to a wireless local area network, researches are carried out on an Institute of Electrical and Electronics Engineers (IEEE) 802.11ax wireless network having higher network efficiency compared to conventional wireless local area networks such as IEEE 802.11n and IEEE 802.11ac. In the 802.11ax wireless network, an electronic device may perform random access based on an orthogonal frequency division multiple access (OFDMA) scheme. With regard to OFDMA, a plurality of electronic devices may transmit/receive data at the same time using different frequency resources. When transmitting/receiving data based on the OFDMA scheme, a transmitting end and a receiving end may share information of radio resources for transmitting/receiving data. Furthermore, the transmitting end and the receiving end may perform timing synchronization.

In the IEEE 802.11ax wireless network, an electronic device may obtain information of radio resources for random access using a trigger frame received from an external electronic device. For example, the external electronic device may designate at least a portion of radio resources as radio resources for contention-based random access, and may add information of the radio resources for contention-based random access to a trigger frame. The electronic device that has received the trigger frame may perform uplink OFDMA-based random access (UORA) through contention on a frequency domain.

When an electronic device and another electronic device perform UORA using the same resource unit, the UORA of the electronic device and the other electronic device may fail since UORA attempts of the electronic device and the other electronic device conflict with each other. In order to reduce the conflict, the electronic device may determine whether to perform the UORA using a specified counter. For example, the electronic device may set an arbitrary OFDMA back-off (OBO) counter within a range of values indicated by an OFDMA contention window (OCW). If a value of the OBO counter is 0 or less when a trigger frame is received, the electronic device may perform the UORA by arbitrarily selecting one among random access-resource units (RA-RUs). If the value of the OBO counter is at least 1 when the trigger frame is received, the electronic device may subtract the number of RA-RUs from the OBO counter.

With regard to the contention-based UORA of an electronic device, an electronic device arbitrarily selects an RA-RU if the OBO counter is 0 or less, and thus there may be a plurality of electronic devices which select the same RA-RU. In particular, as the number of electronic devices which perform the UORA increases in the same network, the probability of conflict between the electronic devices may increase. Due to the conflict between the electronic devices performing the UORA, a large number of RA-RUs may be wasted, and a total throughput of a network may fall.

### SUMMARY

Embodiments of the disclosure may provide an electronic device which selects a radio resource for random access based on a group.

An electronic device according to an example embodiment of the present disclosure includes: a communication circuit, a processor operatively connected to the communication circuit, and a memory operatively connected to the processor, wherein the memory may store one or more instructions that, when executed, cause the processor to control the electronic device to: receive a signal including resource information for random access from an external electronic device using the communication circuit; determine random access corresponding to the received signal based on a value of a specified counter; identify a group to which the electronic device belongs based on an address of the electronic device and a number of groups of electronic devices for random access; and transmit a signal for random access to the external electronic device using a resource unit corresponding to a group of the electronic device among a plurality of resource units indicated by the resource information for random access, based on a random access determination.

An electronic device according to an example embodiment of the present disclosure includes: a communication circuit, a processor operatively connected to the communication circuit, and a memory operatively connected to the processor, wherein the memory may store one or more instructions that, when executed, cause the processor to control the electronic device to: receive a signal including resource information for random access from an external electronic device using the communication circuit; identify a first group to which the electronic device belongs among a plurality of groups based on a medium access control (MAC) address of the electronic device and a number of the plurality of groups of electronic devices for random access; and transmit a signal for random access to the external electronic device using a resource unit corresponding to the first group among a plurality of resource units indicated by the resource information for random access.

A random access method of an electronic device according to an example embodiment of the present disclosure may include: receiving a signal including resource information for random access from an external electronic device of the electronic device; determining random access corresponding to the received signal based on a value of a specified counter; identifying a group to which the electronic device belongs based on an address of the electronic device and a number of groups of electronic devices for random access; and transmitting a signal for random access to the external electronic device using a resource unit corresponding to a group of the electronic device among a plurality of resource units indicated by the resource information for random access, based on a random access determination.

According to various example embodiments of the present disclosure, a conflict may be reduced between electronic devices performing random access by selecting random access resources based on a group.

According to various example embodiments of the present disclosure, radio resource efficiency of a network may be increased and/or improved.

Besides, various effects may be provided that are directly or indirectly identified through the present disclosure.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example electronic device in a network environment according to various embodiments;

FIG. 2 is a block diagram illustrating an example configuration of a network according to various embodiments;

FIG. 3 is a diagram illustrating an example UORA conflict situation according to various embodiments;

FIG. 4 is a diagram illustrating an example format of a trigger frame according to various embodiments;

FIG. 5 is a flowchart illustrating an example random access method according to various embodiments;

FIG. 6 is a flowchart illustrating an example group setting method according to various embodiments;

FIG. 7 is a flowchart illustrating an example group setting method according to various embodiments;

FIG. 8 is a diagram illustrating an example of random access resource selection according to various embodiments;

FIG. 9 is a diagram illustrating example allocation of random access resources according to various embodiments;

FIG. 10 is a flowchart illustrating an example random access method according to various embodiments.

In describing the drawings, the same or similar reference numerals can be used for the same or similar components.

### DETAILED DESCRIPTION

Hereinafter, various example embodiments of the disclosure will be described with reference to the accompanying drawings. It should be understood that the embodiments and the terms used herein are not intended to limit the technology described in the present disclosure to specific embodiments, but rather include various modifications, equivalents and/or alternatives of the embodiments.

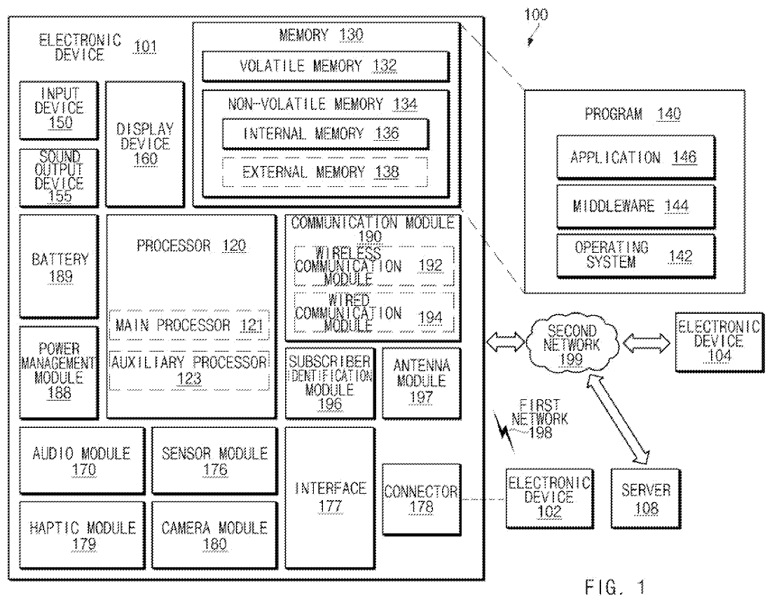

FIG. 1 is a block diagram illustrating an example electronic device 101 in a network environment 100 according to various embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, a keyboard, or a digital pen (e.g., a stylus pen).

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., PCB). According to an embodiment, the antenna module 197 may include a plurality of antennas. In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B”, “at least one of A and B”, “at least one of A or B”, “A, B, or C”, “at least one of A, B, and C”, and “at least one of A, B, or C” may include any one of, or all possible combinations of the items enumerated together in a corresponding one of the phrases. As used herein, such terms as “1st” and “2nd”, or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with”, “coupled to”, “connected with”, or “connected to” another element (e.g., a second element), the element may be coupled with the other element directly (e.g., wiredly), wirelessly, or via a third element.

As used herein, the term “module” may include a unit implemented in hardware, software, or firmware, or any combination thereof, and may interchangeably be used with other terms, for example, “logic”, “logic block”, “part”, or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor(e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

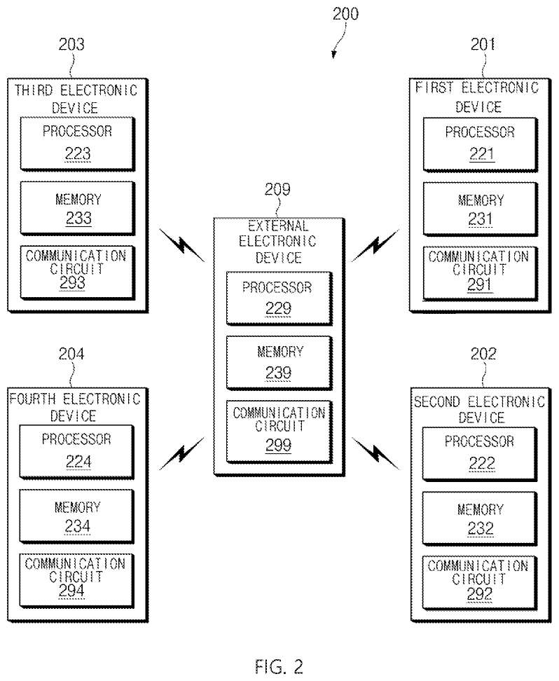

FIG. 2 is a block diagram illustrating an example configuration of a network 200 according to various embodiments.

The network 200 according to various embodiments may include a plurality of electronic devices. For example, as an IEEE 802.11ax wireless network, the network 200 may include a first electronic device 201, a second electronic device 202, a third electronic device 203, a fourth electronic device 204, and an external electronic device 209. The number of electronic devices of the network 200 illustrated in FIG. 2 is an example, and embodiments of the present disclosure are not limited thereto.

According to various embodiments, each of the plurality of electronic devices 201, 202, 203, 204, and 209 may have a structure similar to that of the electronic device 101 of FIG. 1. For example, the first electronic device 201 may include a processor (e.g., including processing circuitry) 221 (e.g., the processor 120 of FIG. 1), a memory 231 (e.g., the memory 130 of FIG. 1), and a communication circuit 291 (e.g., the communication module 190 of FIG. 1). For example, the communication circuit 291 may be referred to as a communicator including a circuitry. For example, the processor 221 may include various processing circuitry and be configured with one or more processors. The first electronic device 201 may include the communication circuit 291, the processor 221 operatively connected to the communication circuit 291, and the memory 231 operatively connected to the processor 221. The memory 231 may store one or more instructions that, when executed, cause the processor 221 to perform various operations. The above descriptions of the first electronic device 201 may likewise apply to other electronic devices (e.g., the second electronic device 202, the third electronic device 203, the fourth electronic device 204, and/or the external electronic device 209). For convenience, overlapping descriptions may not be repeated here. For example, communications circuits 291, 292, 293, 294 and 299 may correspond to each other, processors 221, 222, 223, 224 and 229 may correspond to each other and memories 231, 231, 233, 234 and 239 may correspond to each other

The configuration of each of the plurality of electronic devices 201, 202, 203, 204, and 209 illustrated in FIG. 2 is merely an example, and embodiments of the present disclosure are not limited thereto. For example, at least a portion of the plurality of electronic devices 201, 202, 203, 204, and 209 may further include a configuration not shown in FIG. 2. In the example of FIG. 2, each of the plurality of electronic devices 201, 202, 203, 204, and 209 may be referred to as a station.

In the example of FIG. 2, the external electronic device 209 may transmit a signal (e.g., a signal including a trigger frame) including information of a random access resource unit for uplink OFDMA-based random access (UORA). For example, the external electronic device 209 may be an access point (AP). Other electronic devices (e.g., the first electronic device 201, the second electronic device 202, the third electronic device 203, and/or the fourth electronic device 204) may be electronic devices that perform contention-based random access. For example, each of the other electronic devices may transmit a signal for random access to the external electronic device 209 using one of units indicated in the information of a random access resource unit indicated by the external electronic device 209.

In the example of FIG. 2, the external electronic device 209 is described as transmitting the signal including the information of a random access resource unit, but embodiments of the present disclosure are not limited thereto. According to various embodiments, the first electronic device 201, the second electronic device 202, the third electronic device 203, or the fourth electronic device 204 may transmit the signal including the information of a random access resource unit.

In the examples below, the descriptions of the first electronic device 201, the second electronic device 202, the third electronic device 203, the fourth electronic device 204, and the external electronic device 209 may likewise apply. Hereinafter, the term “random access” may encompass the term “uplink OFDMA-based random access (UORA)”.

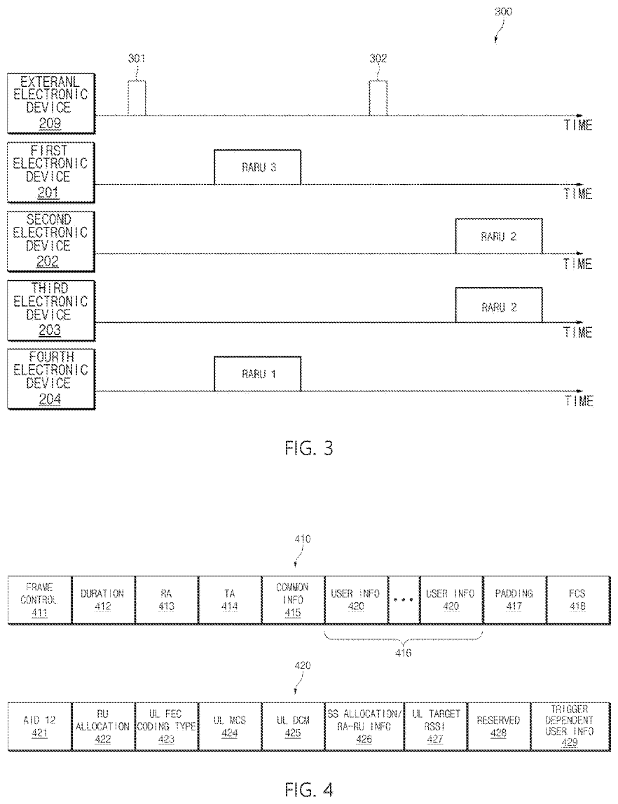

FIG. 3 is a diagram illustrating an example UORA conflict situation 300 according to various embodiments.

According to various embodiments, upon receiving a trigger frame from the external electronic device 209, an electronic device (e.g., the first electronic device 201, the second electronic device 202, the third electronic device 203, and/or the fourth electronic device 204) may determine to transmit a signal for random access according to a value of a specified counter set in the electronic device. According to an embodiment, the electronic device may identify (e.g., select) a value (e.g., positive integer) of an arbitrary counter (e.g., OBO counter) within a specified range (e.g., OCW). When the trigger frame is received, the electronic device may subtract the number of resource units for random access indicated by the trigger frame from the identified counter value, and then may determine whether to transmit the signal for random access based on the counter value. For example, if the counter value is 0 or less, the electronic device may transmit the signal for random access by selecting one of the resource units for random access indicated by the trigger frame. If the counter value is at least 1, the electronic device may not transmit the signal for random access. According to an embodiment, a minimum value of the counter may be set to 0. For example, if a value obtained by subtracting the number of resource units for random access from the counter value is a negative integer, the counter value may be set to 0.

Referring to FIG. 3, according to an embodiment, the external electronic device 209 may transmit a first trigger frame 301. For example, the first trigger frame 301 may include information indicating three resource units as resource units for random access.

According to an embodiment, upon receiving the first trigger frame 301, each of the first electronic device 201, the second electronic device 202, the third electronic device 203, and the fourth electronic device 204 may subtract the number of resource units for random access indicated by the first trigger frame 301 from an initial value of the counter. For example, if a value obtained by subtracting the number of resource units for random access from the initial value of the counter is a negative integer, the counter value may be set to 0. For example, the initial value of the counter of the first electronic device 201 may be 3, the initial value of the counter of the second electronic device 202 may be 5, the initial value of the counter of the third electronic device 203 may be 4, and the initial value of the counter of the fourth electronic device 204 may be 2. For example, after receiving the first trigger frame 301, the counter value of the first electronic device 201 may be updated to 0, the counter value of the second electronic device 202 may be updated to 2, the counter value of the third electronic device 203 may be updated to 1, and the counter value of the fourth electronic device 204 may be updated to 0.

According to an embodiment, since the counter values are 0 or less, the first electronic device 201 and the fourth electronic device 204 may transmit the signal for random access using one of the three resource units indicated by the first trigger frame 301. For example, the first electronic device 201 may transmit the signal for random access using a third random access-resource unit (RA-RU) 3, and the fourth electronic device 204 may transmit the signal for random access using a first RA-RU 1.

According to an embodiment, the first electronic device 201 and the fourth electronic device 204 may initialize the counter value after transmitting the signal for random access in response to reception of the first trigger frame 301. For example, each of the first electronic device 201 and the fourth electronic device 204 may identify (e.g., select) an arbitrary value within a specified range (e.g., OCW). For example, the counter value of the first electronic device 201 may be initialized to 4, and the counter value of the fourth electronic device 204 may be initialized to 5.

According to an embodiment, the external electronic device 209 may transmit a second trigger frame 302. For example, the second trigger frame 302 may comprise information indicating two resource units as resource units for random access.

According to an embodiment, upon receiving the second trigger frame 302, each of the first electronic device 201, the second electronic device 202, the third electronic device 203, and the fourth electronic device 204 may subtract the number of resource units for random access indicated by the second trigger frame 302 from the counter value. For example, after receiving the second trigger frame 302, the counter value of the first electronic device 201 may be updated to 2, the counter value of the second electronic device 202 may be updated to 0, the counter value of the third electronic device 203 may be updated to 0, and the counter value of the fourth electronic device 204 may be updated to 3.

According to an embodiment, since the counter values are 0 or less, the second electronic device 202 and the third electronic device 203 may transmit the signal for random access using one of the two resource units indicated by the second trigger frame 302. For example, the second electronic device 202 and the third electronic device 203 may transmit the signal for random access using a second RA-RU 2. In this case, a conflict may occur between the second electronic device 202 and the third electronic device 203. The second electronic device 202 and the third electronic device 203 may not successfully perform random access due to the counter value when the first trigger frame 301 is received and due to the conflict when the second trigger frame 302 is received. Therefore, random access of the second electronic device 202 and the third electronic device 203 may be delayed.

Hereinafter, according to various example embodiments, an electronic device (e.g., the first electronic device 201, the second electronic device 202, the third electronic device 203, and/or the fourth electronic device 204) may reduce a conflict by selecting a resource unit for random access based on a group.

FIG. 4 is a diagram illustrating an example format of a trigger frame 410 according to various embodiments.

According to various embodiments, the trigger frame 410 may include a frame control field 411, a duration field 412, a recipient address (RA) field 413, a target address (TA) field 414, common information 415, a user information field 416, a padding field 417, and a frame control sequence (FCS) field 418.

According to an embodiment, the frame control field 411 may include information for controlling a frame, such as a protocol version, type, subtype, To distribution system (DS), From DS, and the like. For example, the frame control field 411 may have a 16-bit length.

According to an embodiment, the duration field 412 may be configured according to a frame type and/or subtype. The duration field 412 may have a 16-bit length.

According to an embodiment, the RA field 413 may include recipient address information and may have a 6-byte length.

According to an embodiment, the TA field 414 may include address information of a station transmitting the trigger frame 410. For example, the TA field 414 may have a 6-byte length.

According to an embodiment, the common information field 415 may include information that may be commonly applied to receiving stations of the trigger frame 410. For example, the common information field 415 may include type information of a trigger frame, information associated with a length of a resource unit allocated by the trigger frame, bandwidth, coding information, and the like. The common information field 415 may have at least 8-byte length.

According to an embodiment, the user information field 416 may include at least one piece of user information 420. Each piece of user information 420 may have at least 5-byte length.

According to an embodiment, the user information 420 may include an association identifier (AID) 12 field 421, a resource unit (RU) allocation field 422, an uplink (UL) forward error correction (FEC) coding type field 423, an uplink modulation and coding scheme (MCS) field 424, an uplink dual carrier modulation (DCM) field 425, a spatial stream (SS) allocation/RA-RU information field 426, an uplink target received signal strength indicator (RSSI) field 427, a reserved field 428, and/or a trigger dependent user information field 429. At least a portion of the foregoing fields may be omitted.

For example, the AID 12 field 421 may indicate an electronic device to perform an uplink using an AID. For example, when the AID 12 field 421 has a value between 1 and 2007, an electronic device having an AID corresponding to the value may perform an uplink. When the AID 12 field 421 has a value of 0 or 2045, this value may indicate that a resource indicated by the user information 420 is a resource for random access. The AID 12 field 421 may have a 12-bit length.

For example, the RU allocation field 422 may have an 8-bit length. The RU allocation field 422 may include information of a resource unit to be used by an electronic device (e.g., station) indicated by the AID 12 field 421. The RU allocation field 422 may include information of a first resource unit of one or more successive resource units allocated in association with the AID 12 field 421.

For example, the UL FEC coding type field 423 may have a 1-bit length. A block check character (BCC) may be used for error correction if a value of the UL FEC coding type field 423 is 0, and a low-density parity check (LDPC) may be used for error correction if the value of the UL FEC coding type field 423 is 1.

For example, the UL MCS field 424 may have a 4-bit length. The UL MCS field 424 may indicate MCS information that may be used for uplink transmission indicated by the trigger frame 410.

For example, the UL DCM field 425 may have a 1-bit length. The UL DCM field 425 may indicate whether the uplink transmission indicated by the trigger frame 410 is DCM transmission.

For example, the SS allocation/RA-RU information field 426 may have a 6-bit length. When the AID 12 field 421 has a value of 0 or 2045, the SS allocation/RA-RU information field 426 may indicate the number of successive resource units allocated for random access. One or more successive resource units allocated for random access may have the same length.

For example, the UL target RSSI field 427 may have a 7-bit length. The UL target RSSI field 427 may include information associated with estimated received signal power received by an access point (AP).

For example, the reserved field 428 may have a 1-bit length.

For example, the trigger dependent user information field 429 may have a variable length. The trigger dependent user information field 429, which is an additional field, may be omitted according to a trigger type.

According to an embodiment, the trigger frame 410 may include the padding field 417. For example, a transmitting station of the trigger frame 410 may add the padding field 417 to ensure that a receiving station receives the trigger frame 410.

According to an embodiment, the FCS field 418 may include sequence number information for controlling a frame and may have a 4-byte length.

Hereinafter, various example embodiments will be described using the electronic device 101 of FIG. 1 as an example. The operations of the electronic device 101 described below may be performed by the first electronic device 201, the second electronic device 202, the third electronic device 203, the fourth electronic device 204, and/or the external electronic device 209.

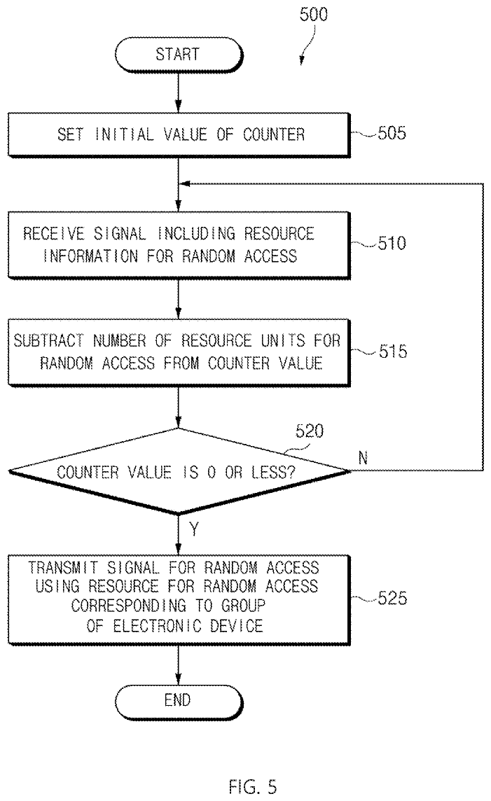

FIG. 5 is a flowchart 500 illustrating an example random access method according to various embodiments.

According to an embodiment, the electronic device 101 may be a station (e.g., a station which is not connected to a network) unassociated with a network. The electronic device 101 may perform random access to a network in order to transmit data via the network. The electronic device 101 may perform the following operations for random access.

According to various embodiments, in operation 505, an electronic device (e.g., the electronic device 101 of FIG. 1) (e.g., the first electronic device 201, the second electronic device 202, the third electronic device 203, or the fourth electronic device 204 of FIG. 2) may set an initial value of a counter (e.g., OBO counter). For example, the electronic device 101 may identify one counter initial value within a specified range (e.g., OCW) of positive integers. For example, the electronic device 101 may identify the range of positive integers based on information received from an external electronic device (e.g., the external electronic device 209). For another example, the electronic device 101 may identify the range of positive integers based on values stored in the memory 130 of the electronic device 101.

According to various embodiments, in operation 510, the electronic device 101 may receive a signal including resource information for random access. For example, the electronic device 101 may receive a signal including a trigger frame from the external electronic device 209. For example, the resource information for random access may include information about a start position of resources for random access and the number of resources for random access.

According to various embodiments, in operation 515, upon receiving the resource information for random access, the electronic device 101 may update a counter value based on the resource information for random access. For example, the electronic device 101 may subtract the number of resource units for random access indicated by a received signal from a set counter value.

According to various embodiments, in operation 520, the electronic device 101 may identify whether the counter value is 0 or less. If the counter value is at least 1, the electronic device 101 may receive a trigger frame until the counter value becomes 0 or less due to reception of a following trigger frame.

According to various embodiments, if the counter value is 0 or less (“Y” in operation 520), the electronic device 101 may transmit a signal for random access using resources for random access corresponding to a group of the electronic device 101 in operation 525. For example, when the electronic device 101 belongs to a third group, the electronic device 101 may transmit the signal for random access using a third resource (e.g., a third resource unit from a start of random access resources) among the resources for random access. For example, the electronic device 101 may transmit the signal for random access to the external electronic device 209.

In the example of FIG. 5, the electronic device 101 may select a random access resource unit corresponding to its own group from among the resources for random access when the counter value is 0. An equal chance of random access may be provided to a plurality of electronic devices by allocating an appropriate group to the plurality of electronic devices attempting to perform random access.

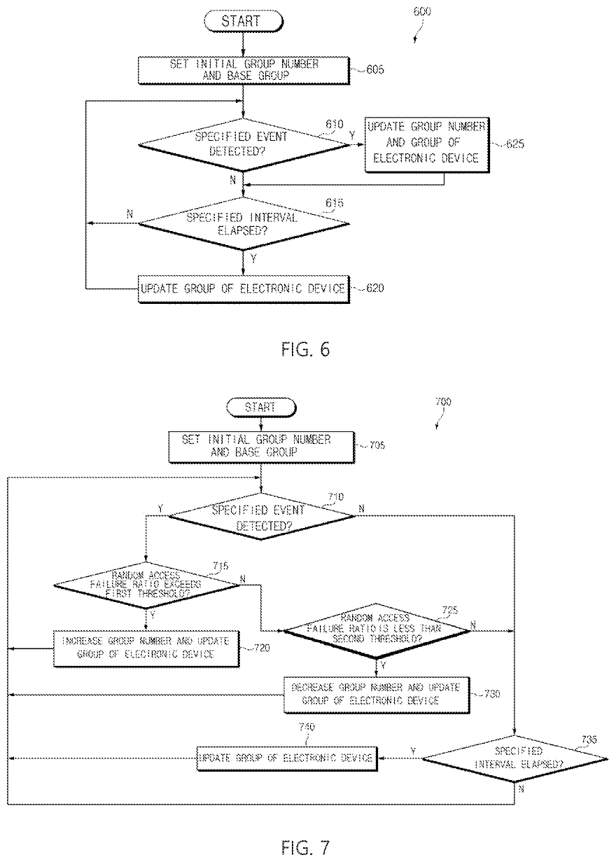

FIG. 6 is a flowchart 600 illustrating an example group setting method according to various embodiments.

According to various embodiments, in operation 605, an electronic device (e.g., the electronic device 101 of FIG. 1) (e.g., the first electronic device 201, the second electronic device 202, the third electronic device 203, or the fourth electronic device 204 of FIG. 2) may set the number of groups and a base group of the electronic device 101. For example, the number of groups may represent the number of groups to which electronic devices performing random access belong.

According to an embodiment, the electronic device 101 may set the number of groups according to a specified value. According to an embodiment, the electronic device 101 may set an initial value of the number of groups to a minimum value of the number of groups.

According to an embodiment, the electronic device 101 may set the base group of the electronic device 101 based on an address (e.g., medium access control (MAC) address) of the electronic device 101. For example, the electronic device 101 may identify the base group of the electronic device 101 according to a modulo operation performed on the address of the electronic device 101 using the number of groups. For example, the electronic device 101 may identify the base group of the electronic device 101 according to equation 1.

Base group=1+(MA mod N) [Equation 1]

In equation 1, MA may denote the MAC address of the electronic device 101 converted into a decimal number, and N may denote the number of configured groups.

Since electronic devices performing random access select resources for random access according to groups to which the electronic devices belong, the electronic devices identify the groups to which the electronic devices belong using a modulo operation, and thus resources for random access may be equally allocated to each groups.

According to various embodiments, in operation 610, the electronic device 101 may determine whether a specified event is detected. For example, the specified event may be reception of a beacon signal from the external electronic device 209. The beacon signal may be a target beacon transmission transmitted from the external electronic device 209 at a specified time interval. In this case, the electronic device 101 may receive the beacon signal every target beacon transmission time (TBTT). The beacon signal is an example of a common time reference between electronic devices for attempting random access, however, embodiments of the present disclosure are not limited thereto. For example, an arbitrary time reference that may be commonly identified by electronic devices (e.g., electronic devices unassociated with a network) in a network may be used as the specified event.

When the specified event is detected (“Y” in operation 610), the electronic device 101 may update the number of groups and a group to which the electronic device 101 belongs in operation 625. As described above in relation to operation 605, the electronic device 101 may identify the group to which the electronic device 101 belongs using the number of groups. Therefore, if the number of groups is updated, the electronic device 101 may update the group to which the electronic device 101 belongs according to the updated number of groups. For example, the electronic device 101 may increase or decrease the number of groups based on a random access situation of the electronic device 101. The update of the number of groups related to operation 625 may be described in greater detail below with reference to FIG. 7.

According to various embodiments, each electronic device may perform hopping of a group to which each electronic device belongs at a specified interval. In operation 615, the electronic device 101 may determine whether the specified interval has elapsed. For example, the electronic device 101 may determine that the specified interval has elapsed if a timer corresponding to the specified interval expires. When the specified interval has not elapsed (“N” in operation 615), the electronic device 101 may monitor detection (e.g., operation 610) of the specified event and elapse (e.g., operation 615) of the specified interval. If the specified interval has elapsed (“Y” in operation 615), the electronic device 101 may update the group of the electronic device 101 in operation 620. For example, if a timer set in the electronic device 101 expires, the electronic device 101 may hop the group of the electronic device 101, and may set a value of the timer to a specified value. According to an embodiment, the electronic device 101 may update the group of the electronic device 101 based on a specified hopping value. For example, the electronic device 101 may update the group of the electronic device 101 according to equation 2.

Group=1+((GN−H) mod N) [Equation 2]

In equation 2, GN may denote a number of a group to which the electronic device 101 currently belongs, H may denote a specified hopping value, and N may denote the number of set groups.

In the example of FIG. 6, since the electronic device 101 hops the group to which the electronic device 101 belongs according to a specified interval, electronic devices performing random access may equally occupy resource units for random access even when the number of resource units for random access allocated by the external electronic device 209 is less than the number of groups.

The above-mentioned base group determination and group hopping method is a non-limiting example, and embodiments of the present disclosure are not limited thereto. According to an embodiment, the electronic device 101 may determine the base group of the electronic device 101 using a different method from that of equation 1. For example, the electronic device 101 may determine the base group based on the number of preset groups and identification information of the electronic device 101. For another example, the electronic device 101 may use a preset base group. According to an embodiment, the electronic device 101 may hop the group to which the electronic device 101 belongs using a different method from that of equation 2. For example, the electronic device 101 may hop the group by as much as a random number or pseudo random number.

FIG. 7 is a flowchart 700 illustrating an example group setting method according to various embodiments.

According to various embodiments, in operation 705, an electronic device (e.g., the electronic device 101 of FIG. 1) (e.g., the first electronic device 201, the second electronic device 202, the third electronic device 203, or the fourth electronic device 204 of FIG. 2) may set the number of groups and a base group of the electronic device 101. The above descriptions of operation 605 of FIG. 6 may be referenced for operation 705.

In operation 710, the electronic device 101 may determine whether a specified event is detected. The above descriptions of operation 610 of FIG. 6 may be referenced for operation 710.

If the event is not detected (“N” in operation 710), the electronic device 101 may determine whether a specified interval has elapsed in operation 735. In operation 740, the electronic device 101 may update a group of the electronic device 101 if the specified interval has elapsed (“Y” in operation 735). The above descriptions of operation 615 and operation 620 of FIG. 6 may be referenced for operation 735 and operation 740 respectively.

According to various embodiments, the electronic device 101 may update the number of groups based on a network situation if the specified event is detected. For example, if the number of groups is excessively small compared to the number of electronic devices performing random access, the probability of conflict between the electronic devices performing random access may increase. For another example, if the number of groups is excessively large compared to the number of electronic devices performing random access, at least a portion of resource units for random access may be wasted.

According to an embodiment, if the specified event is detected, the electronic device 101 may update the number of arbitrary groups based on a ratio of random access failures that occurred during a time interval (e.g., TBTT) between a previously detected event and a currently detected event. For example, the electronic device 101 may identify the ratio of random access failures from the number of attempted random accesses and the number of failed random accesses during a time interval between a previous event and a current event. For example, the electronic device 101 may identify that random access has failed if acknowledgement for random access is not received.

According to an embodiment, the electronic device 101 may update the number of groups based on an upper limit and lower limit of the ratio of random access failures. For example, the electronic device 101 may update the number of groups if the ratio of random access failures exceeds the upper limit or is less than the lower limit. For another example, the electronic device 101 may maintain the number of groups if the ratio of random access failures is at least the lower limit and at most the upper limit.

According to various embodiments, in operation 715, the electronic device 101 may determine whether the ratio of random access failures exceeds a first threshold. For example, the first threshold may correspond to the upper limit of the ratio of random access failures. For example, when the number of groups is excessively small, the ratio of random access failures of the electronic device 101 may increase due to a conflict with another electronic device.

According to various embodiments, in operation 720, the electronic device 101 may increase the number of groups if the ratio of random access failures exceeds the first threshold. According to an embodiment, the electronic device 101 may increase the number of groups according to a specified rule. For example, the electronic device 101 may increase the number of groups within a specified maximum value. For example, the electronic device 101 may increase the number of groups by as many as a specified number. For another example, the electronic device 101 may increase the number of groups in proportion to the ratio of random access failures. For another example, the electronic device 101 may increase the number of groups by as many as a specified multiple. According to an embodiment, the electronic device 101 may increase the number of groups according to equation 3.

N′=2N(while N′≤N_max) [Equation 3]

In equation 3, N′ may denote the updated number of groups, N may denote the number of groups, and N_max may denote the maximum number of groups.

According to an embodiment, the electronic device 101 may update the group to which the electronic device 101 belongs according to the updated number of groups. For example, the electronic device 101 may update the group to which the electronic device 101 belongs according to equation 1.

According to various embodiments, if the ratio of random access failures is equal to or less than the first threshold, the electronic device 101 may determine whether the ratio of random access failures is less than a second threshold in operation 725. For example, when the number of groups is excessively large, a random access failure of the electronic device 101 may reduce, but resource units for random access may be wasted.

According to various embodiments, in operation 730, the electronic device 101 may decrease the number of groups if the ratio of random access failures is less than the second threshold. According to an embodiment, the electronic device 101 may decrease the number of groups according to a specified rule. For example, the electronic device 101 may decrease the number of groups within a specified minimum value. For example, the electronic device 101 may decrease the number of groups by as many as a specified number. For another example, the electronic device 101 may decrease the number of groups in proportion to the ratio of random access failures. For another example, the electronic device 101 may decrease the number of groups by as many as a specified weight. According to an embodiment, the electronic device 101 may decrease the number of groups according to equation 4.

N′=N/2(while N_min≤N′) [Equation 4]

In equation 4, N′ may denote the updated number of groups, N may denote the number of groups, and N_min may denote the minimum number of groups.

According to an embodiment, the electronic device 101 may update the group to which the electronic device 101 belongs according to the updated number of groups. For example, the electronic device 101 may update the group to which the electronic device 101 belongs according to equation 1.

In above operations 715, 720, 725, and 730, the electronic device 101 may maintain the number of groups when the ratio of random access failures is at most the first threshold and at least the second threshold. Since the number of groups is adaptively adjusted according to a network situation, the probability of random access failure may be maintained within a certain range even when the number of electronic devices attempting random access increases.

For example, above operations 715, 720, 725, and 730 may correspond to operation 625 of FIG. 6. Above operations 715, 720, 725, and 730 are examples, and embodiments of the present disclosure are not limited thereto. For example, the electronic device 101 may determine whether to update the number of groups based on the number of random access failures rather than the ratio of random access failures. In this case, the electronic device 101 may increase the number of groups if the number of random access failures detected within a specified event exceeds a first threshold, and may decrease the number of groups if the number of random access failures is less than a second threshold.

The above-mentioned method for changing the number of groups is an example, and embodiments of the present disclosure are not limited thereto. The electronic device 101 may increase and/or decrease the number of groups using a method different from that of equation 3 and/or equation 4.

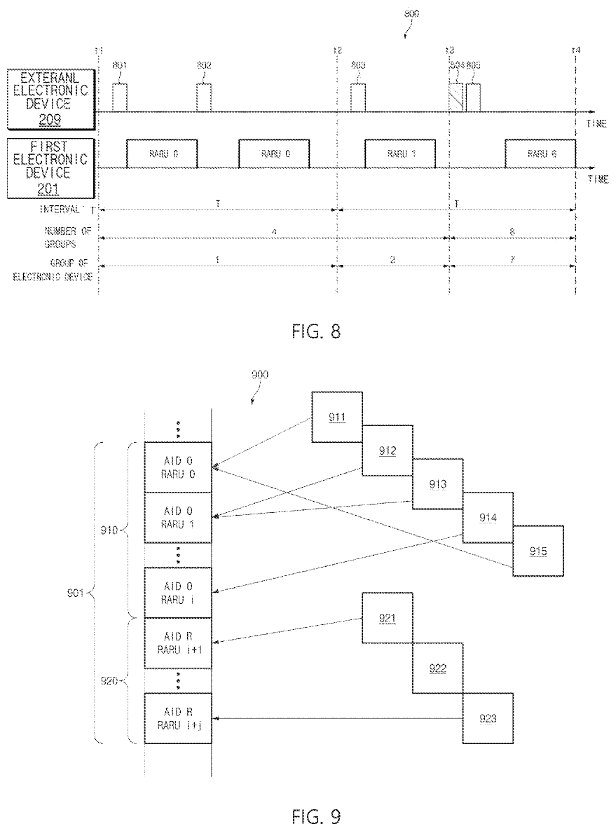

FIG. 8 is a diagram illustrating an example of random access resource selection according to various embodiments.

In the example of FIG. 8, it may be assumed that the number of groups initially set to the first electronic device 201 is 4 and a group set to the first electronic device is a first group. For example, at a time t1, the first electronic device 201 may be in a state in which the number of groups and the group are initialized. For example, if a counter (e.g., OBO counter) of the first electronic device 201 is 0 upon receiving a first trigger frame 801 from the external electronic device 209, the first electronic device 201 may attempt random access using a first random access resource RA-RU 0 corresponding to the first group. For example, if the counter (e.g., OBO counter) of the first electronic device 201 is 0 when a second trigger frame 802 is received from the external electronic device 209, the first electronic device 201 may attempt random access using the first random access resource RA-RU 0 corresponding to the first group. For example, the first electronic device 201 may be unable to receive ACK for random access corresponding to the first trigger frame 801 and the second trigger frame 802.

For example, after a hopping interval T has elapsed, the first electronic device 201 may update the group of the first electronic device 201 according to above equation 2. For example, a hopping value may be 3. Therefore, the group of the first electronic device 201 may be updated to a second group. If the counter of the first electronic device 201 is 0 when a third trigger frame 803 is received from the external electronic device 209, the first electronic device 201 may attempt random access using a second random access resource RA-RU 1 corresponding to a second group.

For example, at a time t3, the first electronic device 201 may receive a beacon frame 804 from the external electronic device 209. In response to reception of the beacon frame, the first electronic device 201 may determine whether to update the number of groups. For example, there may be three random access attempts and two random access failures between reception of a previous beacon frame (not shown) and reception of the beacon frame 804. In this case, the ratio of random access failures is 66%. For example, when the upper limit (e.g., first threshold) of the ratio of random access failures is 60%, the first electronic device 201 may increase the number of groups. For example, the first electronic device 201 may increase the number of groups to 8 according to equation 3. Furthermore, the first electronic device 201 may update the group to which the first electronic device 201 belongs to a seventh group based on the increased number of groups.

If a fourth trigger frame 805 is received and the counter of the first electronic device 201 is 0, the first electronic device 201 may perform random access using a random access resource corresponding to the updated group. For example, the first electronic device 201 may perform random access using a seventh random access resource RA-RU 6 corresponding to the seventh group.

According to various embodiments, the electronic device 101 may determine whether to perform random access based on a counter and may select a resource unit for random access based on a group. In the above-mentioned embodiments of FIGS. 6, 7, and 8, the electronic device 101 may perform group determination (e.g., operation 605 of FIG. 6) based on an address of the electronic device 101, group hopping (e.g., operations 615 and 620 of FIG. 6) according to a specified interval, and updating of the number of groups (e.g., operations 610 and 625 of FIG. 6) based on a specified event. However, embodiments of the present disclosure are not limited thereto.

According to an embodiment, the electronic device 101 may only perform group determination (e.g., operation 605 of FIG. 6) based on an address. According to an embodiment, the electronic device 101 may only perform group determination (e.g., operation 605 of FIG. 6) based on an address and group hopping (e.g., operations 615 and 620 of FIG. 6) according to a specified interval. According to an embodiment, the electronic device 101 may only perform group determination (e.g., operation 605 of FIG. 6) based on an address and updating of the number of groups (e.g., operations 610 and 625 of FIG. 6) based on a specified event.

In the above-mentioned embodiments of FIGS. 6, 7, and 8, electronic devices performing random access may perform cooperative random access by selecting random access resources based on a group. However, embodiments of the present disclosure are not limited thereto. According to an embodiment, centralized control may be performed by a control device in a network. For example, an access point (AP) or one of electronic devices participating in UORA may periodically transfer, as a control device, the number of groups to other electronic devices. For example, the control device may determine the number of electronic devices belonging to one group and/or the number of groups based on the number of electronic devices participating in random access, and may periodically transfer the determined number of groups to other electronic devices. The electronic devices that have received the number of groups may determine a base group based on the number of groups. The electronic devices may hop groups to which the electronic devices belongs at a specified interval. Referring back to FIG. 6, the specified event of operation 610 may be the number of groups received from another electronic device (e.g., control device). In this case, in operation 625, the electronic device 101 may update the group of the electronic device 101 based on the number of groups. For example, the electronic device 101 may update the group of the electronic device 101 according to above equation 1.

According to various embodiments, when the control device performs centralized control, the control device may transmit control information (e.g., the number of groups) using a radio resource and/or radio protocol different from that of a network for random access. For example, the control device may transmit the control information through a frequency band that does not overlap with a radio resource of a network. The control device may transmit the control information via a wireless network such as Bluetooth, Wi-Fi direct, or neighbor awareness network (NAN). According to an embodiment, the control device may transmit the control information using a specified action and/or specified information element for transmitting the control information.

FIG. 9 is a diagram illustrating example allocation 900 of random access resources according to various embodiments.

For example, some electronic devices performing random access in a network environment may select a random access resource unit based on a group as described above with reference to FIGS. 2, 3, 4, 5, 6, 7 and 8. However, other electronic devices performing random access may select arbitrary random access resource units regardless of a group if an OBO counter becomes 0. As described above, in a network environment in which electronic devices performing cooperative random access (e.g., group-based random access) and electronic devices performing non-cooperative random access (e.g., non-group-based random access) coexist, a conflict may increase as the number of electronic devices performing non-cooperative random access increases. In this case, an electronic device (e.g., the external electronic device 209 of FIG. 2) which allocates resources may provide an incentive to electronic devices performing cooperative random access of a network.

According to various embodiments, a resource allocating electronic device may allocate at least a portion of a plurality of resource units for random access as random access resource units for electronic devices performing cooperative random access. For example, the resource allocating electronic device may set a value of an AID 12 field (e.g., the AID 12 field 412 of FIG. 4) to a specified value so as to indicate that a resource indicated by corresponding user information is a random access resource unit for electronic devices performing cooperative random access. For example, the resource allocating electronic device may set the value of the AID 12 field of the user information indicating a random access resource unit (hereinafter referred to as a cooperative random access resource unit) for electronic devices performing cooperative random access to a value other than a value (e.g., value between 1 and 2007) indicating a specific AID and a value (e.g., 0 and 2045) indicating RA-RU for all electronic devices. In this case, electronic devices performing cooperative random access may perform random access using resource units corresponding to groups of the electronic devices among cooperative random access resource units.

Referring to FIG. 9, the resource allocating electronic device may allocate i+1+j number of resource units 901 as resources for random access. For example, the resource allocating electronic device may allocate i+1 number of random access resource units as non-cooperative random access resources 910 and may allocate j number of random access resources as cooperative random access resources 920.

According to an embodiment, a first electronic device 911, a second electronic device 912, a third electronic device 913, a fourth electronic device 914, and a fifth electronic device 915 may perform non-cooperative random access. For example, since the first electronic device 911, the second electronic device 912, the third electronic device 913, the fourth electronic device 914, and the fifth electronic device 915 perform random access by selecting arbitrary resource units among the non-cooperative random access resources 910 if the value of the OBO counter is 0, the conflict probability of random access may increase. For example, since the first electronic device 911 and the fifth electronic device 915 use the same resource unit, a conflict may occur between the first electronic device 911 and the fifth electronic device 915. Since the second electronic device 912 and the third electronic device 913 use the same resource unit, a conflict may occur between the second electronic device 912 and the third electronic device 913.

According to an embodiment, a first cooperative electronic device 921, a second cooperative electronic device 922, and a third cooperative electronic device 923 may perform cooperative random access. For example, the first cooperative electronic device 921 and the third cooperative electronic device 923 may perform random access using resource units corresponding to their own groups among the cooperative random access resources 920 if the value of the OBO counter is 0.

According to various embodiments, an electronic device (e.g., the electronic device 101 of FIG. 1) may perform cooperative random access or non-cooperative random access according to a setting. For example, the electronic device 101 may provide a user interface for selecting cooperative random access or non-cooperative random access. The electronic device 101 may perform cooperative random access or non-cooperative random access based on a user input to the user interface. According to an embodiment, the electronic device 101 may provide statistical information associated with random access to the user interface. For example, the electronic device 101 may provide a user with conflict probability information according to each random access mode. According to an embodiment, the electronic device 101 may provide a guide for selecting a random access mode. For example, the electronic device 101 may recommend cooperative random access or non-cooperative random access to the user according to the conflict probability information according to each random access mode. According to an embodiment, the electronic device 101 may perform cooperative random access or non-cooperative random access based on the conflict probability information according to each random access mode.

Even when an additional random access resource for cooperative random access is configured as in the embodiment of FIG. 9, the electronic device 101 may perform random access according to the methods described above with reference to FIGS. 3 to 8. According to an embodiment, the electronic device 101, upon receiving a trigger frame, may change the value of the OBO counter based on the number of random access resource units corresponding to a random access mode. For example, when the electronic device 101 performs cooperative random access, the electronic device 101 may subtract, from the value of the OBO counter, the number of resource units of a cooperative random access resource indicated by the trigger frame. For another example, when the electronic device 101 performs non-cooperative random access, the electronic device 101 may subtract, from the value of the OBO counter, the number of resource units of a non-cooperative random access resource indicated by the trigger frame. According to an embodiment, the electronic device 101 may select a random access resource based on a random access mode if the value of the OBO counter is 0 or less. For example, the electronic device 101 may arbitrarily select one of resource units of a non-cooperative random access resource in a non-cooperative random access mode, and may perform random access using the selected resource unit. For another example, in a cooperative random access mode, the electronic device 101 may perform random access using a resource unit corresponding to a group of the electronic device 101 among resource units of a cooperative random access resource. When the electronic device 101 belongs to a kth group, the electronic device 101 may perform random access using a kth resource unit among resource units of a cooperative random access resource. For another example, in the cooperative random access mode, the electronic device 101 may perform random access using a resource unit corresponding to the group of the electronic device 101 among all resource units of a random access resource.

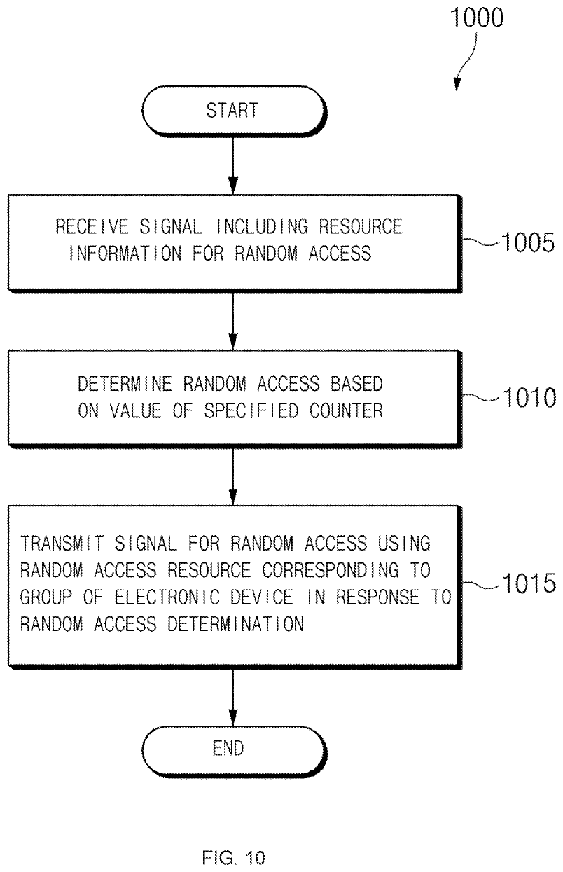

FIG. 10 is a flowchart illustrating an example random access method according to various embodiments.

According to various example embodiments, an electronic device (e.g., the electronic device 101 of FIG. 1) may include a communication circuit (e.g., the communication module 190 of FIG. 1), a processor (e.g., the processor 120 of FIG. 1 and/or the communication module 190 of FIG. 1) operatively connected to the communication circuit, and a memory (e.g., the memory 130 of FIG. 1) operatively connected to the processor. For example, the memory may store one or more instructions that, when executed, cause the processor to control the electronic device to perform the operations described below. The operations of the electronic device may be performed by the first electronic device 201, the second electronic device 202, the third electronic device 203, the fourth electronic device 204, and/or the external electronic device 209 of FIG. 2.

According to various embodiments, in operation 1005, the processor may receive a signal including resource information for random access. For example, the processor may receive a signal including a trigger frame that includes resource information for random access from an external electronic device (e.g., the external electronic device 209 of FIG. 2) using the communication circuit. For example, the resource information for random access may include information about a start point of resources for random access and the number of resources for random access.

According to various embodiments, in operation 1010, the processor may determine whether to perform random access based on a value of a specified counter (e.g., OBO counter). For example, the processor may subtract, from the value of the counter, the number of resource units for random access indicated by the resource information for random access, and may determine to perform random access using one of indicated resource units for random access if the value of the counter is 0 or less. According to an embodiment, a resource for random access may be a random access resource dedicated for cooperative random access.

According to various embodiments, in operation 1015, the processor may transmit a signal for random access using random access resource corresponding to a group of the electronic device in response to the determination of random access.

According to an embodiment, the processor may determine whether to perform operation 1015 further considering a random access mode of the electronic device. For example, when the electronic device is configured to perform cooperative random access, the processor may perform 1015. For another example, when the electronic device is configured to perform non-cooperative random access, the processor may transmit a signal for random access using an arbitrary resource unit among random access resources.

According to various embodiments, the processor may generate, update, and/or adjust information of the group to which the electronic device belongs and the number of groups. According to an embodiment, the processor may set a group based on the number of set groups and an address (e.g., MAC address) of the electronic device. According to an embodiment, the processor may hop the group of the electronic device based on a specified interval. For example, the processor may hop the group to which the electronic device belongs at a specified interval within the number of set groups. According to an embodiment, the processor may update the number of groups and the group to which the electronic device belongs based on a specified event. For example, the specified event may include reception of a beacon signal or a specified interval. The specified event may include any event common to a network. The processor may increase, decrease, or maintain the number of groups based on a network situation (e.g., the ratio of random access failures or the number of random access failures).

According to various example embodiments, an electronic device (e.g., the electronic device 101 of FIG. 1) may include a communication circuit (e.g., the communication module 190 of FIG. 1), a processor (e.g., the processor 120 of FIG. 1) operatively connected to the communication circuit, and a memory (e.g., the memory 130 of FIG. 1) operatively connected to the processor. For example, the memory may store one or more instructions that, when executed, cause the processor to control the electronic device to perform the operations described below. The operations of the processor of the electronic device may be performed by the first electronic device 201, the second electronic device 202, the third electronic device 203, the fourth electronic device 204, and/or the external electronic device 209 of FIG. 2.

According to an example embodiment, the processor may receive a signal including resource information for random access from an external electronic device using the communication circuit, may determine random access corresponding to the received signal based on a value of a specified counter, may identify a group to which the electronic device belongs based on an address of the electronic device and the number of groups of electronic devices for random access, and may transmit a signal for random access to the external electronic device using a resource unit corresponding to a group of the electronic device among a plurality of resource units indicated by the resource information for random access, based on a random access determination.

According to an example embodiment, the resource information for random access may include a start position of the resource unit and the number of the resource units.

According to an example embodiment, the processor may update the value of the counter using the number of resource units for random access indicated by the resource information for random access upon receiving the signal including the resource information for random access, and may determine random access corresponding to the received signal when the updated value of the counter corresponds to a specified range.

According to an example embodiment, the processor may hop the group to which the electronic device belongs within a range of the number of the groups at a specified interval.

According to an example embodiment, the processor may update the number of the groups by increasing, decreasing, or maintaining the number of the groups based on a network situation upon receiving a beacon signal from the external electronic device, and may identify the group to which the electronic device belongs based on the updated number of the groups.

According to an example embodiment, the processor may increase the number of the groups when a random access failure ratio exceeds a first threshold.

According to an example embodiment, the processor may decrease the number of the groups when the random access failure ratio is less than a second threshold.

According to an example embodiment, the processor may receive information about the number of the groups from the external electronic device, may update the number of the groups using the information about the number of the groups, and may identify the group to which the electronic device belongs based on the updated number of the groups.

According to an example embodiment, the processor may perform the random access based on a first protocol, and the information about the number of the groups may be received using a second protocol that is different from the first protocol. For example, the first protocol may include a wireless local area communication protocol based on Institute of Electrical and Electronics Engineers (IEEE) 802.11ax.

According to an example embodiment, the processor may receive a signal including resource information for random access from an external electronic device using the communication circuit, may identify a first group to which the electronic device belongs among a plurality of groups based on a medium access control (MAC) address of the electronic device and the number of the plurality of groups of electronic devices for random access, and may transmit a signal for random access to the external electronic device using a resource unit corresponding to the first group among a plurality of resource units indicated by the resource information for random access.

For example, the resource information for random access may include a start position of the plurality of resource units and the number of the plurality of resource units.

According to an example embodiment, the processor may update a counter value using the number of resource units for random access indicated by the resource information for random access upon receiving the signal including the resource information for random access, and may transmit the signal for random access in response to the received signal when the updated counter value corresponds to a specified range.

According to an example embodiment, the processor may hop a group to which the electronic device belongs from the first group to another group among the plurality of groups.

According to an example embodiment, the processor may update the number of the plurality of groups by increasing, decreasing, or maintaining the number of the plurality of groups based on a random access failure ratio upon receiving a beacon signal from the external electronic device, and may change the group to which the electronic device belongs based on the updated number of the plurality of groups.

According to various example embodiments, a random access method of an electronic device may include: receiving a signal including resource information for random access from an external electronic device of the electronic device; determining random access corresponding to the received signal based on a value of a specified counter; identifying a group to which the electronic device belongs based on an address of the electronic device and the number of groups of electronic devices for random access; and transmitting a signal for random access to the external electronic device using a resource unit corresponding to a group of the electronic device among a plurality of resource units indicated by the resource information for random access, based on a random access determination.

For example, the resource information for random access may include a start position of the resource unit and the number of the resource units.

According to an example embodiment, the determining of the random access corresponding to the received signal based on the value of the specified counter may include: updating the value of the counter using the number of resource units for random access indicated by the resource information for random access upon receiving the signal including the resource information for random access; and determining the random access corresponding to the received signal when the updated value of the counter corresponds to a specified range.

According to an example embodiment, the random access method may further include hopping the group to which the electronic device belongs within a range of the number of the groups at a specified interval.

According to an example embodiment, the random access method may further include: updating the number of the groups by increasing, decreasing, or maintaining the number of the groups based on a network situation upon receiving a beacon signal from the external electronic device; and identifying the group to which the electronic device belongs based on the updated number of the groups.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents.

1. An electronic device comprising:
a communication circuit;
a processor operatively connected to the communication circuit; and
a memory operatively connected to the processor,
wherein the memory stores one or more instructions that, when executed, cause the processor to control the electronic device to:
receive a signal including resource information for random access from an external electronic device using the communication circuit;
determine random access corresponding to the received signal based on a value of a specified counter;
identify a group to which the electronic device belongs based on an address of the electronic device and a number of groups of electronic devices for random access; and
transmit a signal for random access to the external electronic device using a resource unit corresponding to a group of the electronic device among a plurality of resource units indicated by the resource information for random access, based on a random access determination.

2. The electronic device of claim 1, wherein the resource information for random access includes a start position of the resource unit and a number of the resource units.

3. The electronic device of claim 2,
wherein the one or more instructions, when executed, cause the processor to:
update the value of the counter using the number of resource units for random access indicated by the resource information for random access based on receiving the signal including the resource information for random access; and
determine random access corresponding to the received signal based on the updated value of the counter corresponding to a specified range.

4. The electronic device of claim 1, wherein the one or more instructions, when executed, cause the processor to hop the group to which the electronic device belongs within a range of the number of the groups at a specified interval.

5. The electronic device of claim 1,
wherein the one or more instructions, when executed, cause the processor to:
update the number of the groups by increasing, decreasing, or maintaining the number of the groups based on a network situation based on receiving a beacon signal from the external electronic device; and
identify the group to which the electronic device belongs based on the updated number of the groups.

6. The electronic device of claim 5, wherein the one or more instructions, when executed, cause the processor to increase the number of the groups based on a random access failure ratio exceeding a first threshold.

7. The electronic device of claim 6, wherein the one or more instructions, when executed, cause the processor to decrease the number of the groups based on the random access failure ratio being less than a second threshold.

8. The electronic device of claim 1,
wherein the one or more instructions, when executed, cause the processor to:
receive information about the number of the groups from the external electronic device;
update the number of the groups using the information about the number of the groups; and
identify the group to which the electronic device belongs based on the updated number of the groups.

9. The electronic device of claim 8,
wherein the one or more instructions, when executed, cause the processor to control the electronic device to:
perform the random access based on a first protocol; and
receive the information about the number of the groups using a second protocol different from the first protocol.

10. The electronic device of claim 9, wherein the first protocol includes a wireless local area communication protocol based on Institute of Electrical and Electronics Engineers (IEEE) 802.11ax.

11. A random access method of an electronic device, comprising:
receiving a signal including resource information for random access from an external electronic device of the electronic device;
determining random access corresponding to the received signal based on a value of a specified counter;
identifying a group to which the electronic device belongs based on an address of the electronic device and a number of groups of electronic devices for random access; and
transmitting a signal for random access to the external electronic device using a resource unit corresponding to a group of the electronic device among a plurality of resource units indicated by the resource information for random access, based on a random access determination.

12. The random access method of claim 11, wherein the resource information for random access includes a start position of the resource unit and the number of the resource units.

13. The random access method of claim 12,
wherein the determining of the random access corresponding to the received signal based on the value of the specified counter includes:
updating the value of the counter using the number of resource units for random access indicated by the resource information for random access based on receiving the signal including the resource information for random access; and
determining the random access corresponding to the received signal based on the updated value of the counter corresponding to a specified range.

14. The random access method of claim 11, further comprising hopping the group to which the electronic device belongs within a range of the number of the groups at a specified interval.

15. The random access method of claim 11, further comprising:
updating the number of the groups by increasing, decreasing, or maintaining the number of the groups based on a network situation based on receiving a beacon signal from the external electronic device; and
identifying the group to which the electronic device belongs based on the updated number of the groups.
